(19) United States
(12) Patent Application Publication
(10) Pub. No.: US 2005/0068254 A1
(43) Pub. Date: Mar. 31, 2005

(54) Display control apparatus, systems, and methods

(76) Inventor: Lawrence A. Booth, Phoenix, AZ (US)

Correspondence Address: Schwegman, Lundberg, Woessner & Kluth, P.A., P.O. Box 2938, Minneapolis, MN, 55402, US

(21) Appl. No.: 10/677,119

(22) Filed: Sep. 30, 2003

(51) Int. Cl. G09G 5/00

(52) U.S. Cl. 345/3.3

(57) ABSTRACT

An apparatus and a system, as well as a method and article, may operate to receive partial-display data, receive color resolution data, receive display resolution data, and update a display using at least one of the partial-display data, the color resolution data, and the display resolution data.

### TECHNICAL FIELD

Various embodiments described herein relate to communicating information generally, including apparatus, systems, and methods used to display information.

### BACKGROUND INFORMATION

Competitive advertising among the manufacturers of various consumer electronics devices, including cellular telephones, personal digital assistants (PDAs), and the like, continues to emphasize reduced size, weight, and power consumption. As a result, much of the engineering design effort for such devices is focused on reducing power requirements, since power consumption tends to affect the other two factors, especially with respect to battery-powered devices.

Displays, in one form or another, are present in many of the electronic devices used by the consuming public. Thus, apparatus, systems, and methods providing the ability to save power with respect to display technology may provide a competitive benefit to those manufacturers that can take advantage of them.

### BRIEF DESCRIPTION OF THE DRAWINGS

FIG. 1 is a block diagram of apparatus and systems according to various embodiments;

FIG. 2 is a flow chart illustrating several methods according to various embodiments, and

FIG. 3 is a block diagram of several articles according to various embodiments.

### DETAILED DESCRIPTION

To enhance display operation efficiency, some embodiments may operate to provide a variety of controls with respect to advanced displays, including those offered in conjunction with handheld devices. Such displays include those having a low refresh rate capability, or a static image retention capability. In conjunction with these displays, some embodiments provide a partial display mode, where only a portion of the display area is transmitted. Some embodiments may also provide a low color resolution mode, and/or a low display resolution mode that help to reduce power consumed by the display and its interface.

The partial display mode may permit updating only a portion of the full display information. This mode may be used, for example, in conjunction with a device that maintains control icons on the display when the device is in a standby operational mode. Another option, low refresh rate capability, can operate to reduce the display update rate from a value of about 60 cycles-per-second down to as little 4 cycles-per-second, or less. In fact, some embodiments support display update via software control, or “on-demand”, permitting fully static operation for bistable displays

The low color resolution and low display resolution modes may lower power consumption by reducing the switching rate of the display interface signals. Color resolution can be reduced, for example, from a 24 bit color output capability to 8 bits of color, or less. The reduced color resolution of 8 bits may lower the power needed for display data transfer to about ⅓ of the 24 bit color resolution value. Another example includes reducing the resolution of a 640×480 pixel display to 320×240 pixels. This may lower the power needed for data transfer to about 1 of the higher resolution value. These and other embodiments will now be more fully-described in conjunction with the figures referenced above.

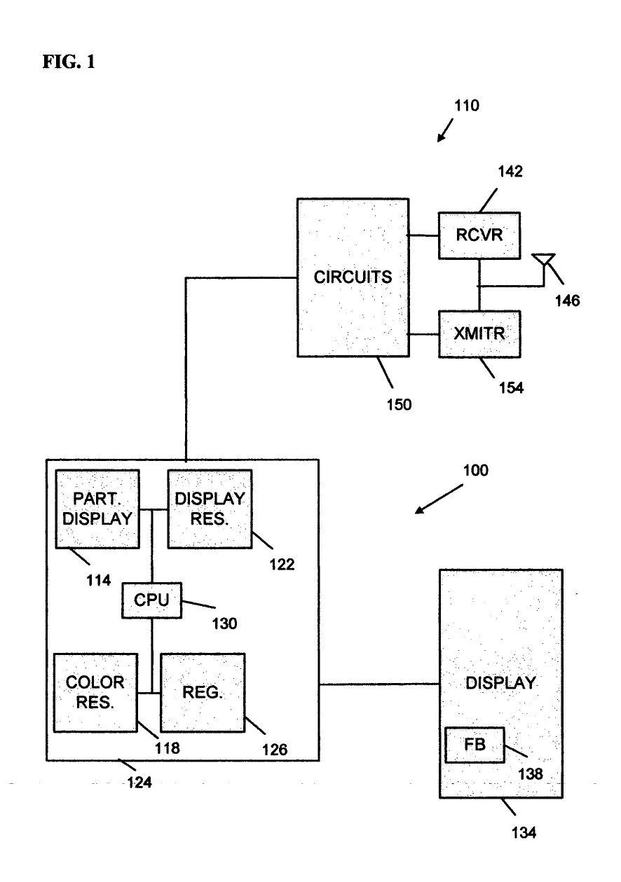

FIG. 1 is a block diagram of apparatus 100 and systems 110 according to various embodiments, each of which may operate in the manner described above. For example, an apparatus 100 may comprise a partial-display module 114, a color resolution module 118, and a display resolution module 122. The apparatus 100, which may comprise a liquid crystal display (LCD) controller 124, may also include one or more data registers 126 (optionally) coupled to a processor 130, the partial-display module 114, the color resolution module 118, and the display resolution module 122. The modules 114, 118, and 122, as well as the registers 126 may form an integrated unit, or exist separately, as shown in FIG. 1. Thus, in some embodiments the apparatus 100 may comprise a controller 124 to receive a combination of data including partial-display data, color resolution data, display resolution data, and/or update rate data. Software updates, including interrupts, may also be used.

The apparatus 100 may also comprise a display 134, including a dynamic-update display (e.g., updated according to the hardware update frequency) or a static-update display (e.g., updated on-demand, according to a software module, object, or routine, or the arrival of data at the apparatus 100). In use, the apparatus 100, as well as the partial-display module 114 may provide a hardware update frequency for the display 134 of between about zero cycles-per-second and about one hundred twenty cycles-per-second, or between about two cycles-per-second and about ten cycles-per-second. The display 134 may be coupled directly or indirectly to the data registers 126. The display 134 may be coupled to a frame buffer 138, which may in turn be coupled to the data registers 126. In use the registers 126, and/or the modules may receive various types of data (described in more detail below) that define the display portion updated, as well as the display resolution, color resolution, and display update rate.

Other embodiments may be realized. For example, the apparatus 100 may operate to receive power management data (perhaps including a battery power notification, a power reduction request, or an alternating current power supply connection notification, among others), and, responsive to receiving the power-management data, modify one or more of the partial-display data, the color resolution data, the update rate data, and the display resolution data. Responsive to receiving the power management request, the apparatus 100 may also operate to modify the portion of the display 134 that is updated, the color resolution of the display 134, the update rate of the display 134, and the display resolution, singly, in any desired combination.

In another embodiment, a system 110, may comprise one or more elements of an apparatus 100 as described above, as well as a receiver 142, an antenna 146 coupled to the receiver 142, and one or more circuits 150 (e.g., processors, multiplexers, etc.) coupled to the apparatus 100 and/or to the receiver 142, which may comprise a cellular telephone receiver or some other form of wireless energy emission receiver, such as a photocell. The antenna 146 may be coupled to a transmitter 154, which may comprise a cellular telephone transmitter or some other form of wireless energy emission transmitter, such as a light emitting diode (LED). The antenna may comprise a monopole antenna, a dipole antenna, an omnidirectional antenna, and a patch antenna, among others.

With respect to either the apparatus 100 or the system 110, the color resolution module 118 may provide a selected amount of color resolution reduction, including reduction amounts selected from a range of about three-fourths to about one-tenth. Similarly, the display resolution module 122 may provide a selected amount of display resolution reduction, including reduction amounts selected a range of about one-half to about one-sixteenth. The display resolution may be reduced in the vertical direction, the horizontal direction, or both.

The apparatus 100, systems 110, partial-display module 114, color resolution module 118, display resolution module 122, controller 124, data registers 126, processors 130, 150, display 134, frame buffer 138, receiver 142, antenna 146, circuits 150, and transmitter 154 may all be characterized as “modules” herein. Such modules may include hardware circuitry, and/or one or more processors and/or memory circuits, software program modules, including objects and collections of objects, and/or firmware, and combinations thereof, as desired by the architect of the apparatus 100 and the systems 110, and as appropriate for particular implementations of various embodiments.

It should also be understood that the apparatus and systems of various embodiments can be used in applications other than for PDAs and telephones, and thus, various embodiments are not to be so limited. The illustrations of apparatus 1 00 and systems 110 are intended to provide a general understanding of the structure of various embodiments, and they are not intended to serve as a complete description of all the elements and features of apparatus and systems that might make use of the structures described herein.

Applications which may include the novel apparatus and systems of various embodiments include electronic circuitry used in high-speed computers, communication and signal processing circuitry, modems, processor modules, embedded processors, and application-specific modules, including multilayer, multi-chip modules. Such apparatus and systems may further be included as sub-components within a variety of electronic systems, such as televisions, telephones, personal computers, workstations, radios, video players, vehicles, and others.

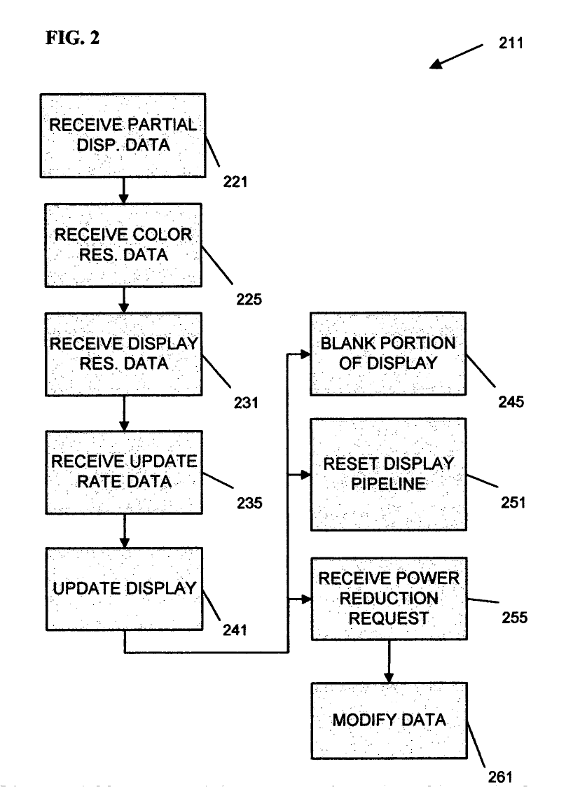

FIG. 2 is a flow chart illustrating several methods according to various embodiments. A method 211 may (optionally) begin with receiving partial-display data at block 221, receiving color resolution data at block 225, receiving display resolution data at block 231, and receiving update rate data at block 235. Such data may be in the form of digital or analog data, including binary bits, analog voltages, and/or carrier waves, modulated or unmodulated.

The method 211 may then continue with updating a display using one or more of the partial-display data, color resolution data, display resolution data, and update rate data that has been received at block 241. The update rate data may include data to implement an update rate of between about zero cycles-per-second and about one hundred twenty cycles-per-second. The update rate data may be provided by a hardware update mechanism, such as a circuit or hardware interrupt, and/or some other form of a hardware update signal, which may provide a display update rate of about zero cycles-per-second to about-one hundred twenty cycles-per-second. The update rate data may also be provided by an on-demand update mechanism, which may comprise a software interrupt, or an on-demand update request, including a programmed update request, or simply the reception of selected display data.

Updating the display at block 241 may further include blanking a portion of the display at block 245, where the portion of the display may be defined by the partial-display data. Updating the display at block 241 may also include resetting a display pipeline to a smaller size defined by the partial-display data at block 251.

The method 211 may also include receiving a power reduction request at block 255, and modifying one or more of the partial-display data, the color resolution data, the update rate data, and the display resolution data responsive to the power reduction request at block 261.

Other, related, embodiments may be realized. For example, a method 211 may include receiving power management data (perhaps including a battery power notification, a power reduction request, or an alternating current power supply connection notification, among others), and, responsive to receiving the power management data, modifying one or more of the partial-display data, color resolution data, update rate data, and display resolution data. Responsive to receiving the power management data, the portion of a display that is updated, the display color resolution, the display update rate, and the display resolution may also be modified. Further, the method 211 may include updating a display in accordance with one or more of the modified update rate data, partial-display data, color resolution data, and display resolution data.

It should be noted that the methods described herein do not have to be executed in the order described, or in any particular order. Moreover, various activities described with respect to the methods identified herein can be executed in serial or parallel fashion. Information, including parameters, commands, operands, and other data, can be sent and received in the form of one or more carrier waves.

Upon reading and comprehending the content of this disclosure, one of ordinary skill in the art will understand the manner in which a software program can be launched from a computer readable medium in a computer-based system to execute the functions defined in the software program. One of ordinary skill in the art will further understand the various programming languages that may be employed to create one or more software programs designed to implement and perform the methods disclosed herein. The programs may be structured in an object-orientated format using an object-oriented language such as Java, Smalltalk, or C++. Alternatively, the programs can be structured in a procedure-orientated format using a procedural language, such as COBOL or C. The software components may communicate using any of a number of mechanisms well-known to those skilled in the art, such as application program interfaces or interprocess communication techniques, including remote procedure calls. The teachings of various embodiments of the present invention are not limited to any particular programming language or environment, including Hypertext Markup Language (HTML) and Extensible Markup Language (XML).

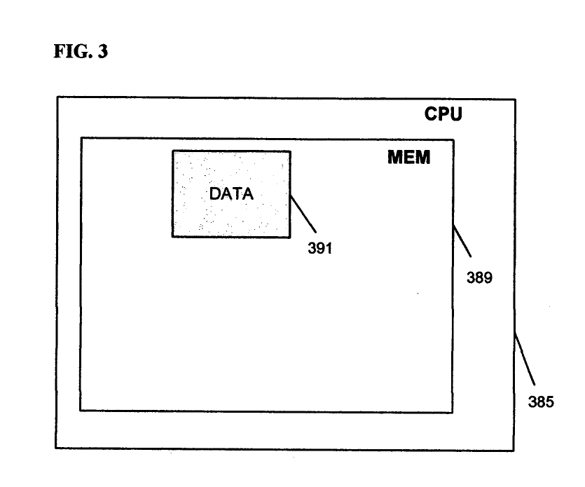

FIG. 3 is a block diagram of several articles 385 according to various embodiments, including a computer, a memory system, a magnetic or optical disk, some other storage device, and/or any type of electronic device or system. The article 385 may comprise a machine-accessible medium such as a memory 389 (e.g., a memory including an electrical, optical, or electromagnetic conductor) having associated data 391 (e.g., computer program instructions), which when accessed, results in a machine performing such actions as receiving partial-display data, receiving color resolution data, receiving update rate data, receiving display resolution data, and updating a display using one or more of the partial-display data, the color resolution data, the update rate data, and the display resolution data. The update rate data may include an on-demand update request (e.g., the arrival and reception of display data), as well as a hardware update signal to provide a display update rate of about zero cycles-per-second to about one hundred twenty cycles-per-second. Other actions may include receiving a power reduction request, and modifying one or more of the partial-display data, the update rate data, the color resolution data, and the display resolution data responsive to the power reduction request.

Reduced display power consumption may result from implementing the apparatus, systems, and methods disclosed herein. Lowering the power required by a display and/or its interface circuitry may provide a more desirable device for manufacturers and the consumers they supply, due to a concomitant decrease in size and/or weight of the device housing the display, especially if the device is battery-powered.

The accompanying drawings that form a part hereof, show by way of illustration, and not of limitation, specific embodiments in which the subject matter may be practiced. The embodiments illustrated are described in sufficient detail to enable those skilled in the art to practice the teachings disclosed herein. Other embodiments may be utilized and derived therefrom, such that structural and logical substitutions and changes may be made without departing from the scope of this disclosure. This Detailed Description, therefore, is not to be taken in a limiting sense, and the scope of various embodiments is defined only by the appended claims, along with the full range of equivalents to which such claims are entitled.

Thus, although specific embodiments have been illustrated and described herein, it should be appreciated that any arrangement calculated to achieve the same purpose may be substituted for the specific embodiments shown. This disclosure is intended to cover any and all adaptations or variations of various embodiments of the invention. Combinations of the above embodiments, and other embodiments not specifically described herein, will be apparent to those of skill in the art upon reviewing the above description.

The Abstract of the Disclosure is provided to comply with 37 C.F.R. § 1.72(b), requiring an abstract that will allow the reader to quickly ascertain the nature of the technical disclosure. It is submitted with the understanding that it will not be used to interpret or limit the scope or meaning of the claims. In addition, in the foregoing Detailed Description, it can be seen that various features are grouped together in a single embodiment for the purpose of streamlining the disclosure. This method of disclosure is not to be interpreted as reflecting an intention that the claimed embodiments of the invention require more features than are expressly recited in each claim. Rather, as the following claims reflect, inventive subject matter lies in less than all features of a single disclosed embodiment. Thus the following claims are hereby incorporated into the Detailed Description, with each claim standing on its own as a separate preferred embodiment.

1. A method, comprising:
receiving partial-display data;
receiving color resolution data;
receiving display resolution data; and
updating a display using at least one of the partial-display data, the color resolution data, and the display resolution data.

2. The method of claim 1, further comprising:
receiving update rate data to implement an update rate of between about zero cycles-per-second and about one hundred twenty cycles-per-second.

3. The method of claim 2, wherein the update rate data is provided by a hardware update mechanism.

4. The method of claim 2, wherein the update rate data is provided by an on-demand update mechanism.

5. The method of claim 1, wherein updating the display further comprises:
resetting a display pipeline to a smaller size defined by the partial-display data.

6. The method of claim 1, wherein updating the display further comprises:
blanking a portion of a display.

7. The method of claim 6, wherein the portion of the display is defined by the partial-display data.

8. An article comprising a machine-accessible medium having associated data, wherein the data, when accessed, results in a machine performing:
receiving partial-display data;
receiving update rate data;
receiving display resolution data; and
updating a display using at least one of the partial-display data, the update rate data, and the display resolution data.

9. The article of claim 8, wherein the update rate data includes an on-demand update request.

10. The article of claim 8, wherein the update rate data includes a hardware update signal to provide a display update rate of about zero cycles-per-second to about one hundred twenty cycles-per-second.

11. The article of claim 8, wherein the data, when accessed, results in the machine performing:
receiving a power reduction request; and
modifying at least one of the partial-display data, the update rate data, and
the display resolution data responsive to the power reduction request.

12. The article of claim 8, wherein the data, when accessed, results in the machine performing:
receiving a power reduction request; and
modifying color resolution data responsive to the power reduction request.

13. An apparatus, comprising:
a partial-display module:
a color resolution module;
a display resolution module; and
a data register coupled to the partial-display module, the color resolution module, and the display resolution module.

14. The apparatus of claim 13, wherein the partial-display module is to provide a hardware update frequency.

15. The apparatus of claim 13, wherein the hardware update frequency is between about zero cycles-per-second and about one hundred twenty cycles-per-second.

16. The apparatus of claim 15, wherein the hardware update frequency is between about two cycles-per-second and about ten cycles-per-second.

17. The apparatus of claim 13, further comprising:
a static-update display to couple to the data register.

18. The apparatus of claim 13, further comprising:
a display coupled to a frame buffer to couple to the data register.

19. A system, comprising:
an apparatus including a partial-display module, a color resolution module, a display resolution module, and a data register to couple to the partial-display module, the color resolution module, and the display resolution module;
a receiver;
an omnidirectional antenna to couple to the receiver; and
a processor to couple to the apparatus and to the receiver.

20. The system of claim 19, wherein the color resolution module is to provide a selected amount of color resolution reduction.

21. The system of claim 20, wherein the selected amount of color resolution reduction is selected from a range of about three-fourths to about one-tenth.

22. The system of claim 19, wherein the display resolution module is to provide a selected amount of display resolution reduction.

23. The system of claim 22, wherein the selected amount of display resolution reduction is selected from a range of about one-half to about one-sixteenth.

24. The system of claim 19, further comprising:
a cellular telephone transmitter coupled to the omnidirectional antenna.

25. An apparatus, comprising:
a controller to receive a combination of data including partial-display data,
color resolution data, display resolution data, and update rate data.

26. The apparatus of claim 25, further comprising:
a static update display to couple to the controller.

27. The apparatus of claim 26, wherein the update rate data is provided by an on-demand update mechanism.

28. An apparatus, comprising:
a controller to modify a combination of data including partial-display data,
color resolution data, display resolution data, and update rate data responsive to receiving power management data.

29. The apparatus of claim 28, wherein the power management data comprises a power reduction request.

30. The apparatus of claim 28, wherein the update rate data is provided by an on-demand update mechanism.

31. A method, comprising:
modifying a combination of data including partial-display data, color resolution data, display resolution data, and update rate data responsive to receiving power management data.

32. The method of claim 31, further comprising:
updating a display in accordance with at least two of the modified update rate data, modified partial-display data, modified color resolution data, and modified display resolution data.

33. The method of claim 31, wherein the power management data includes a battery connection notification.

34. The method of claim 31, wherein the power management data includes an alternating current power supply connection notification.
